(19) United States
(12) Patent Application Publication
(10) Pub. No.: US 2005/0097764 A1
(43) Pub. Date: May 12, 2005

(54) Enhanced visibility of overlay measurement marks

(76) Inventor: Su Hyun Kim, Kuching (MY)

Correspondence Address: THI D. DANG;Lawrence Y D Ho & Associates, PMB 400, 2101 Crystal Plaza Arc, Arlington, VA, 22202, US

(21) Appl. No.: 10/703,551

(22) Filed: Nov. 10, 2003

(51) Int. Cl. G01B 3/14

(52) U.S. Cl. 33/562

(57) ABSTRACT

A method of improving the visibility of the overlay measurement marks before overlay measurement process. The visibility of a global alignment mark is enhanced by inserting a dummy pattern around the global alignment mark so that the metrology tool can readily find it. The dummy pattern is a pattern of geometric shapes having contrasting tones, whereby a high tonal contrast is created for the global alignment mark relative to the surrounding area, which includes the overlay measurement marks and the scribe lines.

### BACKGROUND OF THE INVENTION

1. Field of the Invention

The present invention relates in general to a technique for recognizing overlay measurement marks before overlay measurement during the fabrication of semiconductor devices.

2. Description of the Prior Art

Typically in the fabrication of semiconductor devices, a plurality of patterned layers are successively formed into a stack on a semiconductor substrate. Photolithography is conventionally used to produce various patterned layers. In photolithography, it is critical that the successive, patterned layers are accurately aligned relative to each other. Presently, it is conventional to use overlay marks of the box-in-box type to measure the overlay or placement error of the patterns. These overlay marks are typically formed at the scribe lines on the semiconductor wafer being processed.

FIG. 1 shows a conventional overlay measurement mark composed of an inner square box mark 2 and an outer box mark 3. The outer box mark 3 has a central box-shaped opening and is formed in a lower layer on the semiconductor substrate. The inner square box mark 2 is formed in an upper layer and is smaller in size than the outer box mark 3. The inner square box mark 2 is positioned over the center of the outer box mark 3 as shown in FIG. 1. The overlay accuracy between the patterned layers is measured by comparing the distances c and d between the inner and outer marks. The distances c and d indicate the degree of overlay and the difference between the two distances is taken as an overlay error in the X axis. Similarly, distances e and f are measured to determine the overlay error in the Y axis. A metrology tool is conventionally used to perform overlay measurements. However, before the overlay measurement can be done, the metrology tool must be able to find the overlay measurement locations. In the conventional overlay alignment and measurement methods, the metrology tool has problem detecting the overlay measurement locations due to low image contrast between the overlay marks and the surrounding area. This is especially true after CMP process when the outer box mark 3 becomes more blurry. In addition, the metrology tool has difficulty in recognizing the conventional overlay marks because the pattern of the inner box 2 and outer box 3 is not unique enough relative to the surrounding area. The waveform shown in FIG. 2 represents the signal obtained from scanning the conventional overlay mark shown in FIG. 1 using the scanner of the metrology tool. The height of the intensity peaks in the waveform depends on the pattern of image contrast. When the image contrast is low, the peaks are also low as shown in FIG. 3, and the metrology tool has difficulty in detecting the overlay measurement locations. Occasionally the signal is too low, e.g. after CMP process, the overlay measurement locations cannot be found and overlay measurement cannot be performed at all.

There remains a need for improving the visibility of the overlay marks so that the metrology tool can easily recognize these marks before overlay measurement can be performed.

### SUMMARY OF THE INVENTION

The present invention provides a method of improving the visibility of the overlay measurement marks before overlay measurement process. The visibility of an overlay measurement mark is enhanced by inserting a dummy pattern around the overlay measurement mark so that the metrology tool can readily find it. The dummy pattern is a pattern of geometric shapes having contrasting tones, whereby a high tonal contrast is created between the overlay measurement mark and the surrounding area.

### BRIEF DESCRIPTION OF THE DRAWINGS

FIG. 1 shows a conventional box-in-box overlay measurement mark.

FIG. 2 shows the waveform representing the image contrast of the conventional overlay measurement mark shown in FIG. 1.

FIG. 3 shows a dummy pattern around an overlay measurement mark in accordance with the preferred embodiment of the present invention.

FIG. 4 shows the waveform representing the image contrast of the overlay measurement mark with the dummy pattern.

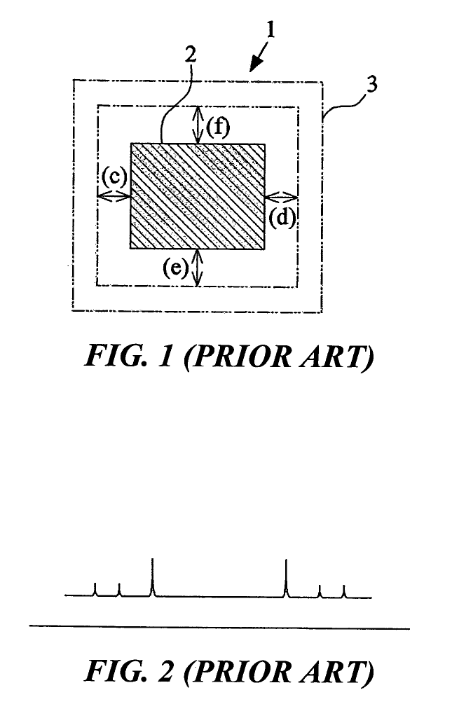

### DETAILED DESCRIPTION OF THE INVENTION

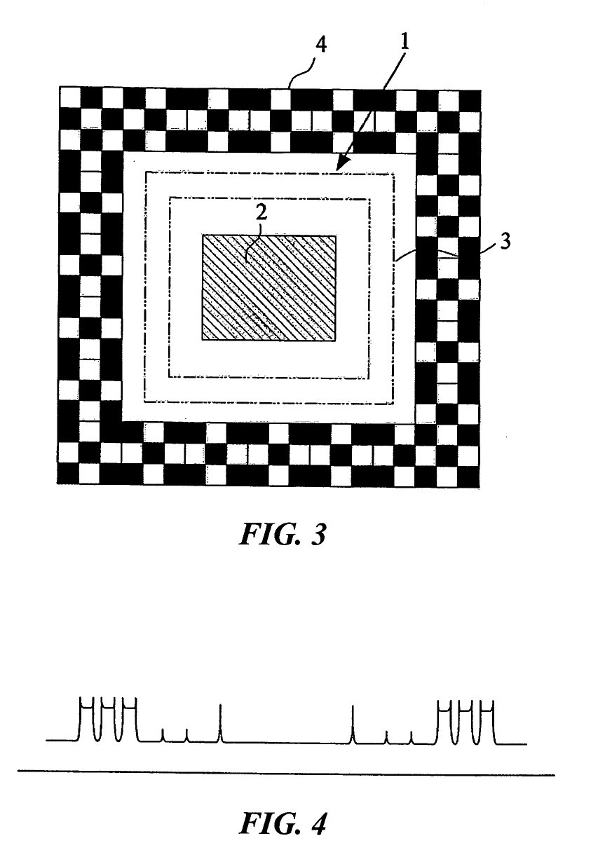

FIG. 3 shows an exemplary dummy pattern being placed around the overlay measurement mark in accordance with the preferred embodiment of the present invention. The dummy pattern is formed by inputting the image of the dummy pattern onto the reticle of an exposure apparatus and then printing out the pattern onto the surface surrounding the overlay measurement mark. As an example, the dummy pattern 4 is a chequered pattern with black and white squares. When the dummy pattern 4 is placed around the outer boundary of the outer box 3a, the global alignment mark 1a can be recognized easily by the metrology tool. Even though a chequered pattern is shown in FIG. 3, it should be understood that other pattern designs with geometric shapes are possible so long as the designs contain contrasting tones. FIG. 4 shows that the signal generated by the metrology scanner is very clear when the dummy pattern is inserted because high tonal contrast is created between the overlay measurement mark enclosed by the dummy pattern and the surrounding area. The dummy pattern is inserted at different locations on the semiconductor wafer where there is a need for unique patterns during the photolithographic process. Once the dummy pattern is inserted, the overlay measurement process is then performed.

While the present invention has been described in terms of the above preferred embodiment, those skilled in the art will recognize that many changes and modifications may be made therein without departing from the scope of the appended claims.

1. A method of enhancing the visibility of an overlay measurement mark before overlay measurement, said method comprising:
providing an overlay measurement mark used for measuring an overlay error during the fabrication of a semiconductor device; wherein the overlay measurement mark comprises an inner box formed in a lower layer and an outer box formed in an upper layer;
placing a dummy pattern around the outer box on the upper layer, wherein the dummy pattern is a pattern of geometric shapes having contrasting tones, whereby a high tonal contrast is created between the global alignment mark with the dummy pattern and the surrounding area;
performing overlay measurement.

2. The method of claim 1, wherein the dummy pattern is a chequered pattern of two contrasting tones.

3. The method of claim 1, wherein the dummy pattern is formed by inputting the image of the dummy pattern onto a reticle of an exposure apparatus and then printing the pattern onto the surface surrounding the outer box.

4. An enhanced overlay measurement mark for use during the fabrication of the a semiconductor device comprising:
an outer box formed in a lower layer;
an inner box formed in an upper layer, wherein the inner box is positioned above the center of the outer box;
a dummy pattern surrounding the outer box on the upper layer, wherein the dummy pattern is a pattern of geometric shapes having contrasting tones, whereby a high tonal contrast is created between the global alignment mark with the dummy pattern and the surrounding area.

5. The global alignment mark of claim 1, wherein the dummy pattern is a chequered pattern of two contrasting tones.
